(19) United States
(12) Patent Application Publication
(10) Pub. No.: US 2010/0218476 A1
(43) Pub. Date: Sep. 2, 2010

(54) RAKE HEAD

(75) Inventor: Gilles Gosselin, Montreal (CA)

Correspondence Address: MCDERMOTT WILL & EMERY LLP, 600 13TH STREET, N.W., WASHINGTON, DC, 20005-3096, US

(73) Assignee: ATLANTIC PROMOTIONS INC.

(21) Appl. No.: 12/548,244

(22) Filed: Aug. 26, 2009

(30) Foreign Application Priority Data
Mar. 2, 2009 (CA) 2,656,662

(51) Int. Cl. A01D 7/00

(52) U.S. Cl. 56/400.16

(57) ABSTRACT

The present invention relates to a rake head, typically for a lawn or garden rake, which optimizes the gathering of matter, facilitates collecting and lifting the gathered matter and also serves as a standard rake. There is provided a rake head adapted for being mounted at an end of a handle and including a first fork having a handle connector for attaching the first fork to the handle, and further including a second fork having a U-shaped connector for removably and radially mounting the second fork with respect to the first fork, the second fork being movable between an unassembled position wherein the second fork is detached from the first fork, and an assembled position wherein the second fork is fixedly disposed in parallel with respect to the first fork.

### FIELD OF THE INVENTION

The present invention relates to a rake head. More particularly, the present invention relates to a rake head to be mounted at the end of a handle.

### BACKGROUND OF THE INVENTION

Known in the art are garden or lawn rakes for gathering matter on the ground, such as leaves and debris. However, with such conventional rakes, matter may slip between the teeth of the rake and be left behind, thus requiring several strokes of the rake and consequently substantial efforts to gather the said matter.

Known to the Applicant are U.S. Pat. No. 4,744,208 in the name of King and granted on May 17, 1998, No. 3,332,223 in the name of Polisso and granted on Jul. 25, 1967 and No. 4,545,189 in the name of Nelson and granted on Oct. 8, 1985, as well as US patent applications No. 2004/0250524 in the name of DeSanti and published on Dec. 16, 2004 and No. 2003/0033793 in the name of Fairbanks and published on Feb. 20, 2003.

King discloses a rake head for a lawn or garden rake having a first and second rows of tines, the tines of the second row extending between and adjacent the tines of the first row of tines, forming two substantially identical rows of raking tines.

Polisso also discloses a similar rake head having spaced and staggered rows of tines so as to engage practically all the surface being raked.

Nelson discloses an attachment to a conventional rake forming a clamp at the rake head, the clamp being operable by a lever attached to the rake handle, such that the rake may be used for grasping matter.

DeSanti discloses a debris gathering and pick-up tool for use in gathering, grasping, lifting and disposing of debris present upon a ground surface. The tool includes a gathering portion having a flattened gathering head, an elongated handle, and a coupling arrangement for coupling the gathering head to the elongated handle at a pre-selected downward angle. The tool further includes a grasping portion which has a flattened grasping member, a user-operable grasping sleeve and a second coupling arrangement establishing a downward angle between the grasping member and the grasping sleeve. The grasping portion is slidably coupled to the gathering portion so as to be movable between a retracted position and a grasping position, as needed for clean-up activities.

Fairbanks discloses a rake panel utilized in combination with a rake. More particularly, the rake panel includes a panel and an opened sleeve configured to removably attach with a rake via an interference fit, either to a rake shaft or to a rake head.

The teachings of the aforementioned documents suffer however from drawbacks. Hence, in light of the aforementioned, there is a need for an improved system which, by virtue of its design and components, would be able to overcome some of the above-discussed prior art concerns.

### SUMMARY OF THE INVENTION

The object of the present invention is to provide a device which, by virtue of its design and components, satisfies some of the above-mentioned needs and is thus an improvement over other related garden or lawn rake heads, rakes and/or methods known in the prior art.

According to the present invention, there is provided a rake head to be mounted at an end of a handle, the rake head comprising a first fork having a handle connector for attaching the first fork to the handle, and a second fork having a U-shaped connector for removably and radially mounting the second fork with respect to the first fork, the second fork being movable between an unassembled position wherein the second fork is detached from the first fork, and an assembled position wherein the second fork is fixedly disposed in parallel with respect to the first fork.

The objects, advantages and features of the present invention will become more apparent upon reading of the following non-restrictive description of preferred embodiments thereof, given for the purpose of exemplification only, with reference to the accompanying drawings.

### BRIEF DESCRIPTION OF THE DRAWINGS

FIG. 1 is a perspective view of a rake head according to a preferred embodiment of the present invention, the rake head being shown in attachment with a rake handle, the rake head having a first fork and a second fork, the second fork being shown in an assembled position.

FIG. 2 is an exploded view of the rake head shown in FIG. 1.

FIG. 3 is a top plan view of the rake head shown in FIG. 1.

FIG. 4 is a bottom plan view of what is shown in FIG. 3.

FIG. 5 is a front elevation view of what is shown in FIG. 3.

FIG. 6 is a rear elevation view of what is shown in FIG. 3.

FIG. 7 is a left side elevation view of what is shown in FIG. 3.

FIG. 8 is a right side elevation view of what is shown in FIG. 3.

FIG. 9 is a top plan view of the first fork of the rake head shown in FIG. 1.

FIG. 10 is a cross-section view of what is shown in FIG. 9, taken along line 4-4, the first fork being shown with a hook.

FIG. 11 is an enlarged view of a detail shown in FIG. 10.

FIG. 12 is a cross-section view of what is shown in FIG. 9, taken along line 2-2.

FIG. 13 is a front elevation view of what is shown in FIG. 9.

FIG. 14 is a rear elevation view of what is shown in FIG. 9.

FIG. 15 is a right side elevation view of what is shown in FIG. 9.

FIG. 16 is a bottom plan view of what is shown in FIG. 9.

FIG. 17 is a cross-section view of what is shown in FIG. 16, taken along line 6-6.

FIG. 18 is a cross-section view of what is shown in FIG. 16, taken along line 8-8.

FIG. 19 is a top plan view of the second fork of the rake head shown in FIG. 1, the second fork having a U-shaped connector.

FIG. 20 is a cross-section view of what is shown in FIG. 19, taken along line 12-12.

FIG. 21 is a cross-section view of the U-shaped connector shown in FIG. 19, taken along line 10-10.

FIG. 22 is a front elevation view of what is shown in FIG. 19.

FIG. 23 is a rear elevation view of what is shown in FIG. 19.

FIG. 24 is a right side elevation view of what is shown in FIG. 19.

FIG. 25 is a bottom plan view of what is shown in FIG. 19.

FIG. 26 is a cross-section view of what is shown in FIG. 25, taken along line 18-18.

FIG. 27 is a cross-section view of what is shown in FIG. 25, taken along line 16-16.

FIG. 28 is a cross-section view of what is shown in FIG. 25, taken along line 14-14.

### DETAILED DESCRIPTION OF PREFERRED EMBODIMENTS OF THE INVENTION

In the following description, the same numerical references refer to similar elements. The embodiments, geometrical configurations, materials mentioned and/or dimensions shown in the figures or described in the present description are preferred embodiments only, given for exemplification purposes only.

In the context of the present invention, the expressions “connector”, “fastener”, “securing means”, “attachment”, and any other equivalent expression and/or compound words thereof known in the art will be used interchangeably.

In addition, preferred embodiments of the present invention as illustrated in the accompanying drawings comprises components such as a first fork, a second fork, a U-shaped connector, teeth, a tongue, a hook, etc., and although the preferred embodiment of the rake head and corresponding parts thereof consists of certain geometrical configurations as explained and illustrated herein, not all of these components and geometries are essential to the invention and thus should not be taken in their restrictive sense, i.e. should not be taken as to limit the scope of the present invention. It is to be understood, as also apparent to a person skilled in the art, that other suitable components and cooperations thereinbetween, as well as other suitable geometrical configurations may be used for the rake head according to the present invention, as will be briefly explained herein and as can be easily inferred herefrom, by a person skilled in the art, without departing from the scope of the invention. The rake head is also called double-forked rake head in the present description.

Broadly described, the double-forked rake head according to the present invention, as exemplified in the accompanying drawings, is a rake head for a rake, typically for use on a lawn or garden surface, which optimizes the gathering of matter by covering a greater surface area, facilitates collecting and lifting the gathered matter by virtue of a removable grasping component and also serves as a standard rake.

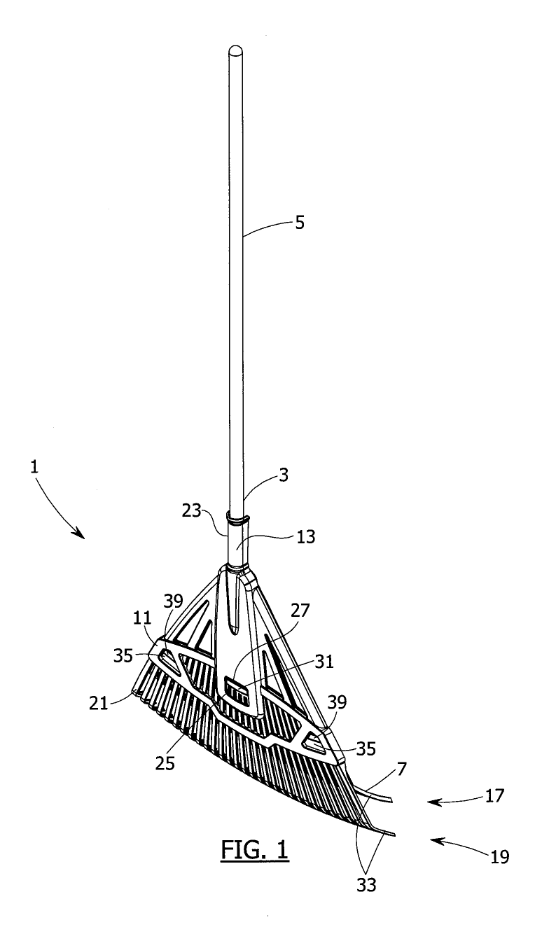

As better illustrated in FIG. 1 of the drawings, the rake head (1) of the present invention is adapted for being mounted at an end (3) of a handle (5) and includes a first fork (7) having a handle connector (9) for attaching the first fork (7) to the handle (5), and a second fork (11) having a U-shaped connector (13) for removably and radially mounting the second fork (11) with respect to the first fork (7), the second fork (11) being movable between an unassembled position wherein the second fork (11) is detached from the first fork (7), and an assembled position wherein the second fork (11) is fixedly disposed in parallel with respect to the first fork (7), as can be easily understood by a person skilled in the art when referring to the accompanying drawings.

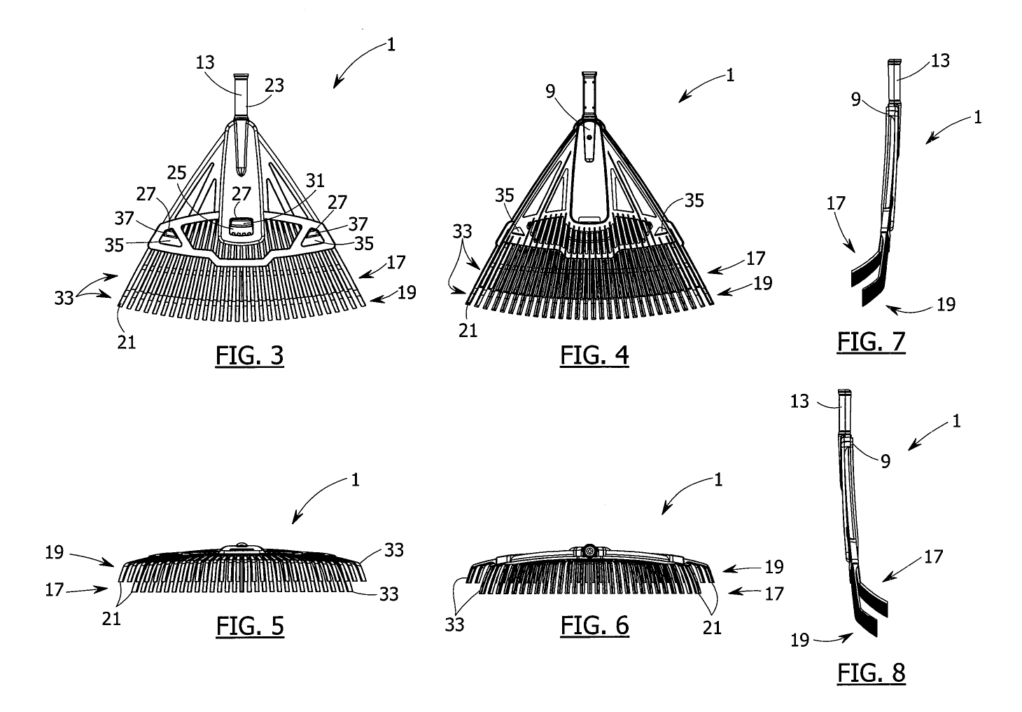

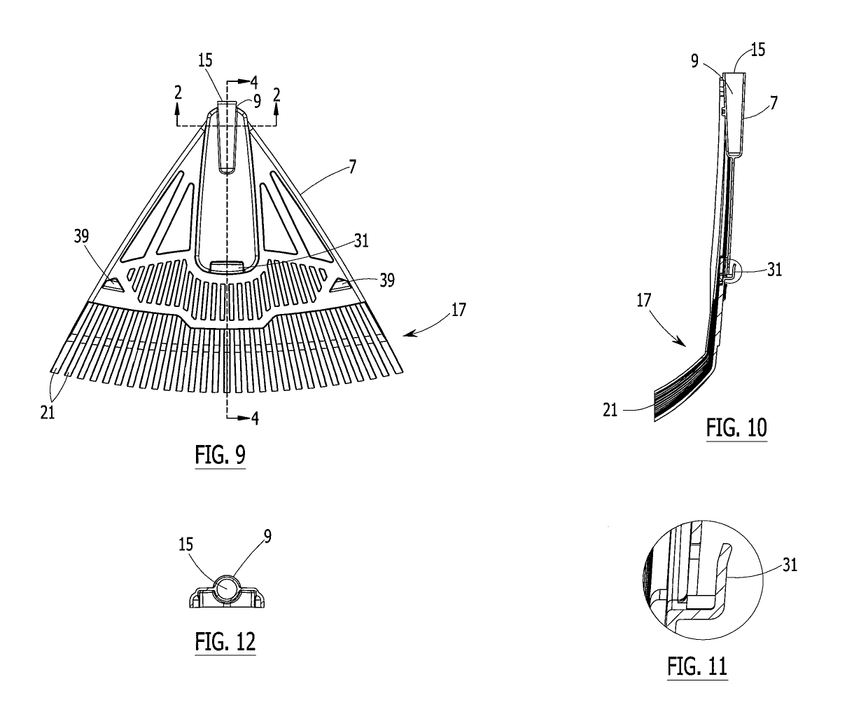

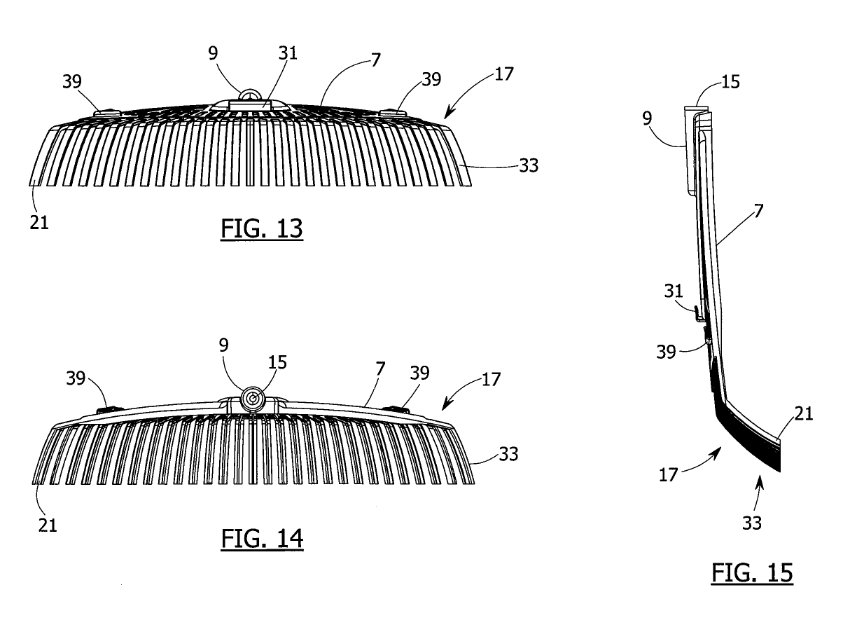

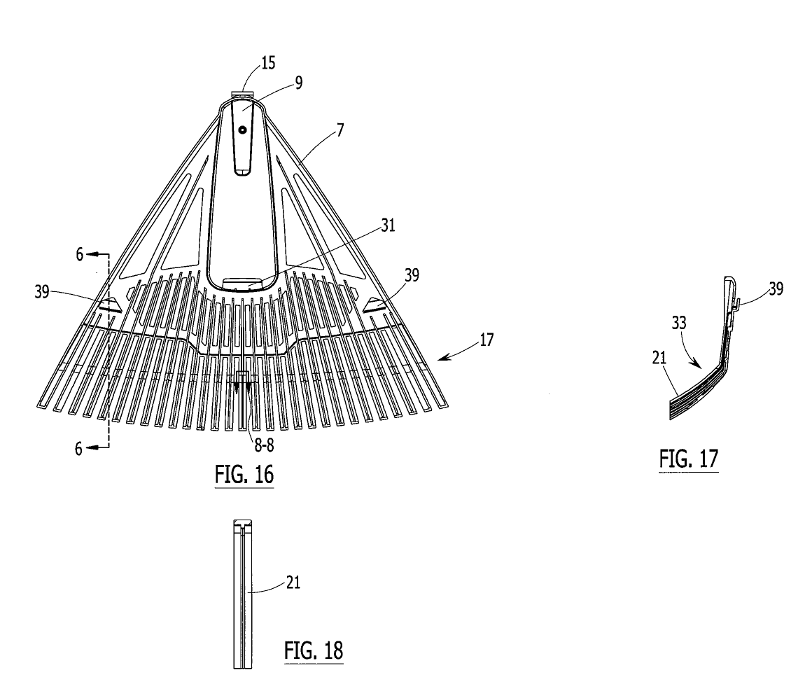

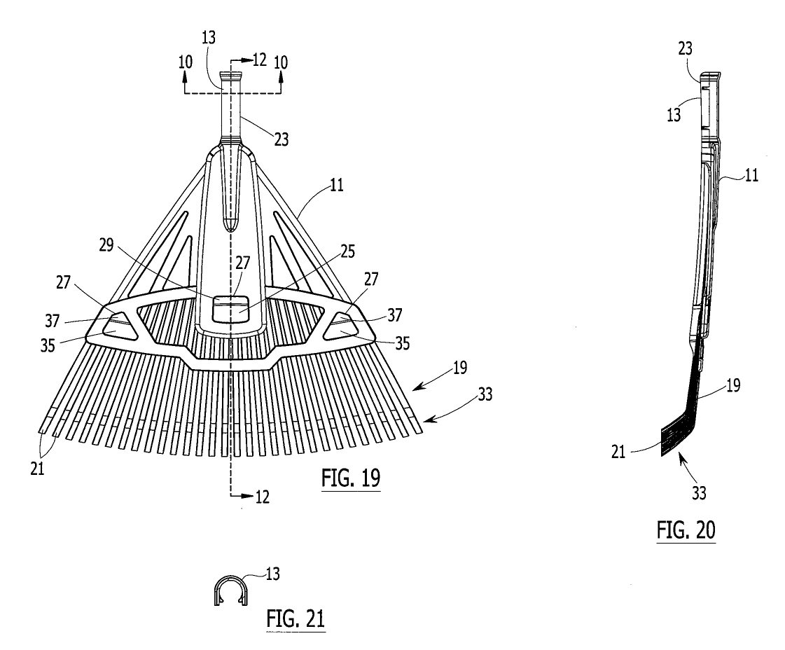

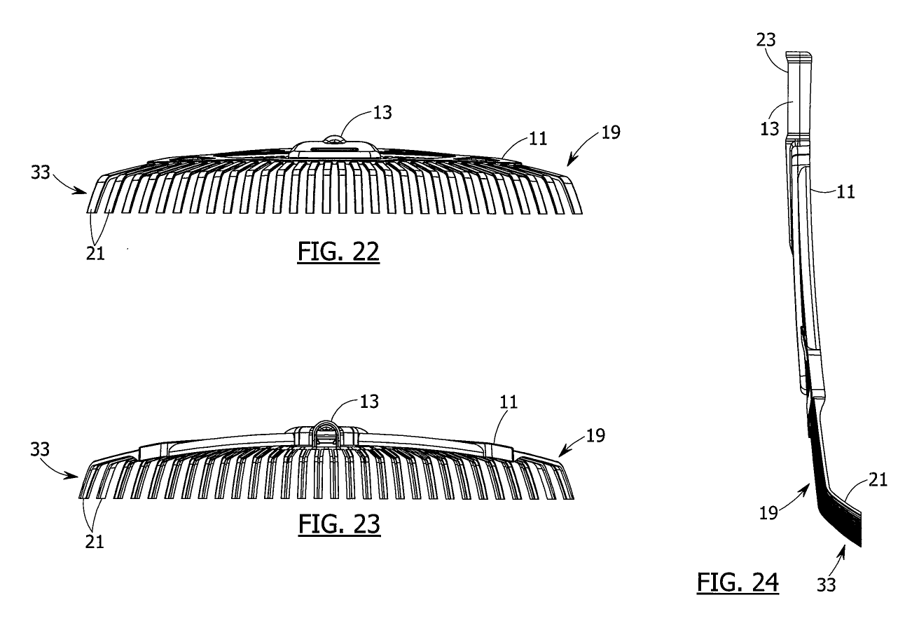

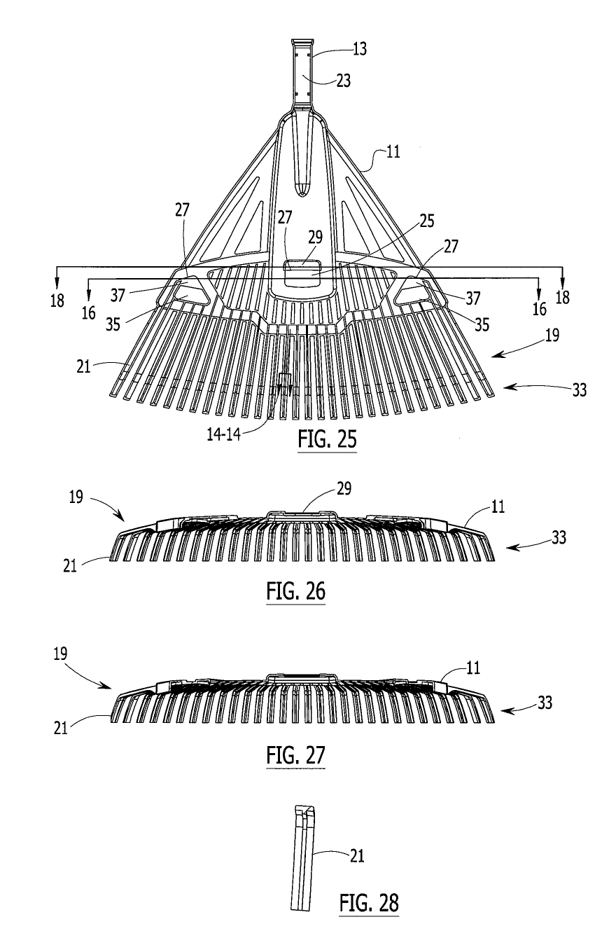

Preferably, referring now to FIGS. 1 to 28 of the drawings, the handle connector (9) of the first fork (7) is defined by a tubular passage (15) for receiving the handle end (3) of a rake. The tubular passage (15) may be threaded so as to receive a complementary threaded end (3) of a handle. Alternatively, the handle may be wedged therein and/or fastened by any suitable fastening means such as, for example, a screw, a push-and-lock mechanism and/or the like, as readily understood by a person skilled in the art.

Preferably, the U-shaped connector (13) of the second fork (11) is adapted to be mounted on the handle of the rake. Preferably, the U-shaped connector (13) is elongated and made of a suitable material so as to be easily attached to and removed from the rake handle and so as to securely attach the second fork (11) thereon. Alternatively, the U-shaped connector (13) may be adapted to be mounted directly onto the first fork (7). Indeed and for example, the first fork (7) may further comprise a complementary protrusion or recess so as to cooperate with the U-shaped connector (13) and thus secure the second fork (11) onto the first fork (7). The second fork (11) may be adapted, in a preferred embodiment, to be attached to the first fork (7) or to the handle (5) of the rake, as can be easily understood by a person skilled in the art. The second fork (11) may further be mounted on the first fork (7) and/or rake handle by using any suitable fastening or biasing means such as a clip, a loop and hook fastener, a magnet, a push-button, a rubber band assembly, a clamp, a hook mechanism, a spring lock and/or the like. Moreover, the second fork (11) may define a cavity for receiving a handle end or a branch of a rake handle (not illustrated). Alternatively, the first fork (7) and/or rake handle may comprise a clamping member or connector for receiving and cooperating with a corresponding component of the second fork (11), to secure the second fork (11), as can be easily understood by a person skilled in the art.

Preferably, the first fork (7) comprises a first row of teeth (17) and the second fork (11) comprises a second row of teeth (19), the second row of teeth (19) extending beyond the first row of teeth (17) when the second fork (11) is in the assembled position. The distance between the first row of teeth (17) and second row of teeth (19) may be any suitable distance. Moreover, the first fork (7) or second fork (11) may form a plurality of rows of teeth. Moreover, the first fork (7) may comprise a row of teeth cooperating with a row of teeth of the second fork (11) so as to form a common row of teeth when assembled.

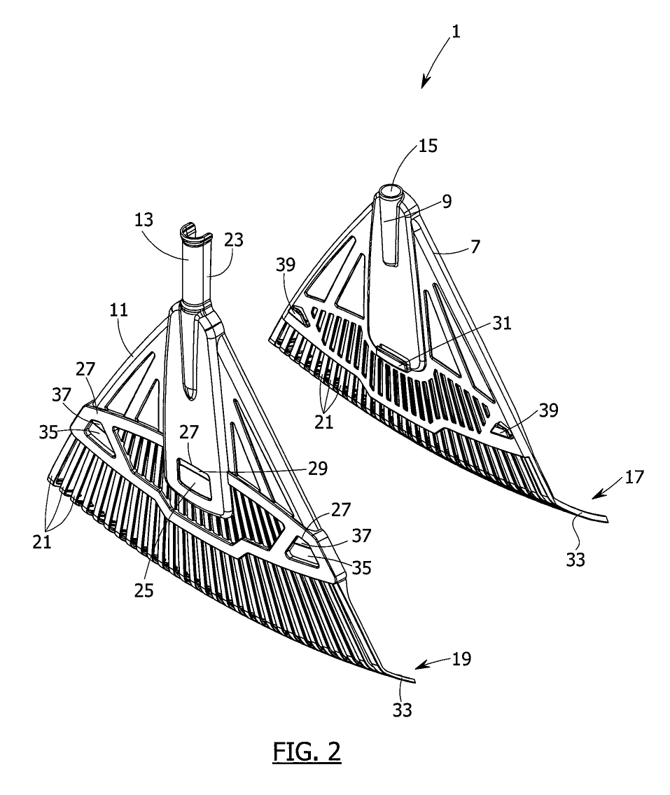

Preferably, the first row of teeth (17) is offset with respect to the second row of teeth (19), as better illustrated in FIG. 2, such that the surface area being covered with a stroke of the rake head (1) corresponds to the totality or almost the totality of the width of the rake head (1). The width of the teeth (21) and the distance between the teeth (21) may vary, as can be easily understood by a person skilled in the art.

Preferably, the U-shaped connector (13) of the second fork (11) forms a handle (23) to facilitate holding the second fork (11) in the unassembled position and clamping matter between the first fork (7) and the second fork (11). Optionally, the first fork (7) may also comprise an elongated handle for facilitating operation thereof when detached from the rake handle. The first and/or second fork (11) may also comprise a D-shaped handle formed on a planar surface thereof.

Preferably, the second fork (11) defines an opening (25) being delimited on a handle side (27) thereof by a tongue (29) and the first fork (7) comprises a hook (31) (see FIGS. 10-11) capable of being inserted in the opening (25) to cooperate with the tongue (29) for securing the second fork (11) onto the first fork (7). Preferably, the second fork defines two secondary openings (35) preferably, on each side thereof, each secondary opening (35) being delimited on the handle side (27) by a secondary tongue (29) and the first fork (7) comprises two corresponding secondary securing hooks (39) (see figures) for further securing the second fork (11) onto the first fork (7). Alternatively, a tongue and hook assembly (29, 31 or 37, 39) may be inversed such that the tongue is on the first fork and the hook is on the second fork. Moreover, other suitable securing means may be provided as can be easily understood by a person skilled in the art. Indeed and for example, a fastening means may be provided between the first and second forks (7,11), for example, a clip, a push-button, a loop and hook fastener, a clamp, etc. Moreover, the hook (31) may be replaced with a biased clip so as to further secure the tongue (29) therein. Furthermore, a biasing assembly may be provided to cooperate with the U-shaped connector (13) so as to further secure the second fork (11) onto the first fork (7). Indeed and for example, a longer U-shaped connector (13) adapted to be attached to the handle of the rake may provide a sufficient biasing force to coerce the second fork (11) in an assembled position. Additional attaching and/or securing and/or biasing means may be included in preferred embodiments of the present invention, as can be easily understood.

Preferably, the teeth of the first fork (7) and the teeth of the second fork (11) have bent ends (33). Alternatively, a portion of the teeth (21) may be bent while others may be straight. Moreover, a portion of the teeth may have ends (33) which are bent at different angles. Furthermore, the rows of teeth (17,19) may be protected at various angles, as can be easily understood by a person skilled in the art.

Preferably, the bent ends (33) of the teeth of the first fork (7) are longer than the bent ends (33) of the teeth of the second fork (11). Alternatively, the bent ends (33) of the teeth may be of different lengths irrespective of their attachment to the first or second fork (7,11). Moreover, the bent ends (33) of the second fork (11) may be longer than the bent ends (33) of the first fork (7).

Preferably, the rake head (1) or components thereof is/are made of polypropylene. Alternatively, the rake head (1) or components thereof may be made of any other suitable material such as aluminum, a polymer and/or the like. Preferably, each of the teeth (21) is reinforced. Moreover, the rake handle or a portion thereof is preferably covered with a foam material (not illustrated).

In operation, the rake head according to a preferred embodiment of the present invention, is connected with a handle and may be used with the second fork in an assembled position, that is, the second fork being fixedly disposed in parallel with respect to the first fork, thus allowing a stroking movement of the rake head against a surface to engage the area corresponding to a totality or almost a totality of the width of the rake head.

The second fork may be readily detached into an unassembled position with respect to the first fork, so as to allow clamping of matter between the first and second forks. Moreover, the first fork may be detached from the handle so as to be directly manipulated for clamping or gathering of matter.

Preferably, the rake comprising the rake head according to the present invention may further be used in a conventional way when the second fork is in an unassembled position, such that the first fork and rake handle assembly form a conventional rake.

Several modifications may be made to the above-described double-forked rake head or double-forked rake, without departing from the scope of the present invention, as can be easily understood by a person skilled in the art. Indeed and for example, the second fork may be adjustably attached onto the first fork so as to allow a lateral and/or longitudinal movement and thus adjust the degree of offset between the teeth and/or the distance between the first row and second row of teeth. Moreover, the second fork may be adjustably attached on the first fork so as to allow the angle of the teeth of the second fork to be varied with respect to the angle of the teeth of the first fork, as can be easily understood by a person skilled in the art. Furthermore, a blocking mechanism may be used to secure the second fork with respect to the first fork, for example by adding a protruding profile on one of the first or second fork and a complementary profile on the corresponding other fork.

Several other modifications may be made to the above-described double-forked rake head without departing from the scope of the present invention. Indeed and for example, the first fork or second fork may further comprise a plurality of rows of teeth which may or may not be offset with respect to one another. Moreover, the second fork may be suited to be mounted underneath the first fork, as can be easily understood by a person skilled in the art.

Moreover, although the present invention is directed to a rake head for a conventional garden or lawn rake, the above-mentioned embodiments may be adapted for other outdoor tools such as a forged rake, a hand rake, etc., as well as for household tools such as, a broom or, sports equipment and/or the like, as can also be easily understood by a person skilled in the art, without departing from the scope of the present invention.

Of course, numerous other modifications may be made to the above-described embodiments without departing from the scope of the invention, as apparent to a person skilled in the art. Indeed, the above-described embodiments are considered in all respect only as illustrative and not restrictive, and the present application is intended to cover any adaptations or variations thereof, as apparent to a person skilled in the art.

1. A rake head to be mounted at an end of a handle, the rake head comprising:
a first fork having a handle connector for attaching the first fork to the handle; and
a second fork having a U-shaped connector for removably and radially mounting the second fork with respect to the first fork, the second fork being movable between an unassembled position wherein the second fork is detached from the first fork, and an assembled position wherein the second fork is fixedly disposed in parallel with respect to the first fork.

2. The rake head according to claim 1, wherein the first fork comprises a first row of teeth and the second fork comprises a second row of teeth, the second row of teeth extending beyond the first row of teeth.

3. The rake head according to claim 1, wherein the first fork comprises a first row of teeth and the second fork comprises a second row of teeth, the first row of teeth being offset with respect to the second row of teeth.

4. The rake head according to claim 1, wherein the U-shaped connector of the second fork forms a handle.

5. The rake head according to claim 1, wherein the second fork defines an opening being delimited on a handle side thereof by a tongue and wherein the first fork comprises a hook capable of being inserted in the opening to cooperate with the tongue for securing the second fork onto the first fork.

6. The rake head according to claim 5, wherein the second fork further defines two secondary openings on each side thereof, each secondary opening being delimited on the handle side by a secondary tongue and wherein the first fork comprises two corresponding secondary securing hooks for further securing the second fork onto the first fork.

7. The rake head according to claim 1, wherein the U-shaped connector of the second fork is elongated to be mounted on said handle of the rake.

8. The rake head according to claim 1, wherein teeth of the first fork and teeth of the second fork have bent ends.

9. The rake head according to claim 8, wherein the bent ends of the teeth of the first fork are longer than the bent ends of the teeth of the second fork

10. The rake head according to claim 1, wherein the rake head is made of polypropylene.
